(19) United States
(12) Patent Application Publication
(10) Pub. No.: US 2005/0271458 A1
(43) Pub. Date: Dec. 8, 2005

(54) Multi-functional pen

(76) Inventor: Weiliang Kui, Ningbo (CN)

Correspondence Address: RAYMOND Y. CHAN, 108 N. YNEZ AVE., SUITE 128, MONTEREY PARK, CA, 91754, US

(21) Appl. No.: 10/861,195

(22) Filed: Jun. 4, 2004

(51) Int. Cl. B43K 29/00

(52) U.S. Cl. 401/195

(57) ABSTRACT

A multi-functional pen includes an elongated pen body having a lower body and an upper body, a writing unit, having a writing tip, disposed in the lower body of the pen body, and a pen actuator provided at the pen body to move the writing unit from a normal unemployed position to an operation position. The multi-function pen further includes an auxiliary functional arrangement including a memory unit received in the upper body of the pen body and a computer connector extended from the upper body of the pen body, wherein the computer connector is electrically connected to the memory unit for detachably connecting with a computer, such that the memory unit forms a removable storage for communicating with the computer to store a computer data thereof.

### BACKGROUND OF THE PRESENT INVENTION

1. Field of Invention

The present invention relates to a writing instrument, and more particularly to a multi-functional pen which comprises an auxiliary functional arrangement received in a pen body for providing an auxiliary function such as an audio player, a computer connector, and/or a recording device, so as to enhance the practical use of the pen.

2. Description of Related Arts

Nowadays, people usually carry lots of different items, such as pen, laptop, and music player, when they go to work, to school, or even shopping. It is a hassle that when they need to use the pen, they will try to look for the pen in a carrying bag while hundreds of items are stored therein. Therefore, people have thousands of ideas to provide an additional function for the pen so as to enhance the practical use of the pen.

Generally speaking, a pen is a common tool that replaces pencils as a writing instrument wherein the pen comprises a hollow pen holder and a pen core disposed along the pen holder. Generally, there are two types of pen, namely a mechanical pen and a disposable pen that the pen core is irreplaceable such that the disposable pen must be thrown away when the ink of the pen core is used up.

Accordingly, the pen core is replaceable for the mechanical pen, wherein the mechanical pen further comprises an actuating unit provided on the pen holder to move the pen core between an operation position and a storage position, wherein at the operation position, a writing end of the pen core is pushed out of an end of the pen holder and at the storage position, the writing end of the pen core is received within the pen holder.

In order to enhance the attraction of the pen, the pen, as disclosed in the U.S. Pat. No. 6,099,185, further comprises an illumination unit operatively incorporated with the pen holder to provide an added lighting effect for the pen. In addition, a recording device is added into the pen such that the pen not only forms a writing instrument but also allows the user to record a predetermined time-length of voice.

It seems that more alternative functions can be incorporated with the pen to provide multi-functional use of the pen. However, the size and shape of the pen is a limitation when more than one functional device is added into the pen. Therefore, the existing pen can only provide one added function such as light device or recording device.

### SUMMARY OF THE PRESENT INVENTION

A main object of the present invention is to provide a multi-function pen, which comprises an auxiliary functional arrangement received in a pen body for providing an auxiliary function such as an audio player, a computer connector, and/or a recording device, so as to enhance the practical use of the pen.

Another object of the present invention is to provide a multi-function pen, which is an all-in-one pen, comprising a memory unit for storing computer readable data such as music data, document data and/or voice data. Therefore, the user is able to use the multi-function pen to play the music via the audio player, to communicate with the computer via the computer connector, and recording and playing back the recorded voice via the recording device.

Another object of the present invention is to provide a multi-function pen, wherein the auxiliary functional arrangement is received in an upper body of the pen body such that the auxiliary functional arrangement is individually operated with the pen. Therefore, the user is able to operate the auxiliary functional arrangement during writing.

Another object of the present invention is to provide a multi-function pen, which does not require to alter the original structural design of the pen, so as to minimize the manufacturing cost of incorporating the auxiliary functional arrangement with every conventional mechanical pen.

Another object of the present invention is to provide a multi-function pen, wherein the auxiliary functional arrangement is adapted to be installed to all kinds of the conventional mechanical pen.

Another object of the present invention is to provide a multi-function pen, wherein no expensive or complicated structure is required to employ in the present invention in order to achieve the above mentioned objects. Therefore, the present invention successfully provides an economic and efficient solution not only for providing a multi-functional application to enhance the utilization of the pen but also for facilitating the practical use of the pen.

Accordingly, in order to accomplish the above objects, the present invention provides a multi-function pen, comprising an elongated pen body having a lower body and an upper body, a writing unit, having a writing tip, disposed in the lower body of the pen body, and a pen actuator provided at the pen body to move the writing unit from a normal unemployed position that the writing tip of the writing unit is received within the pen body to an operation position that the writing tip of the writing unit is pushed out of the pen body at a lower end thereof.

The multi-function pen further comprises an auxiliary functional arrangement, which comprises a memory unit received in the upper body of the pen body and a computer connector extended from the upper body of the pen body, wherein the computer connector is electrically connected to the memory unit for detachably connecting with a computer, such that the memory unit forms a removable storage for communicating with the computer to store a computer data thereof.

Alternatively, the auxiliary functional arrangement comprises an audio player electrically connected to the memory unit for playing a music data stored therein.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a multi-function pen according to a preferred embodiment of the present invention.

FIG. 2 is an exploded perspective view of the multi-function pen according to the above preferred embodiment of the present invention.

FIG. 3 is a sectional view of the multi-function pen according to the above preferred embodiment of the present invention.

FIG. 4 is a block diagram of the auxiliary functional arrangement of the multi-function pen according to the above preferred embodiment of the present invention.

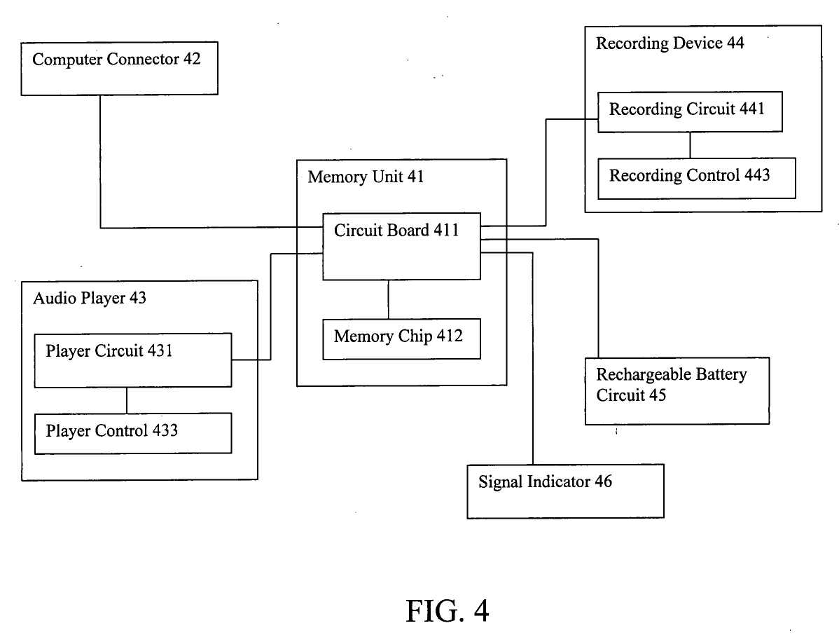

### DETAILED DESCRIPTION OF THE PREFERRED EMBODIMENT

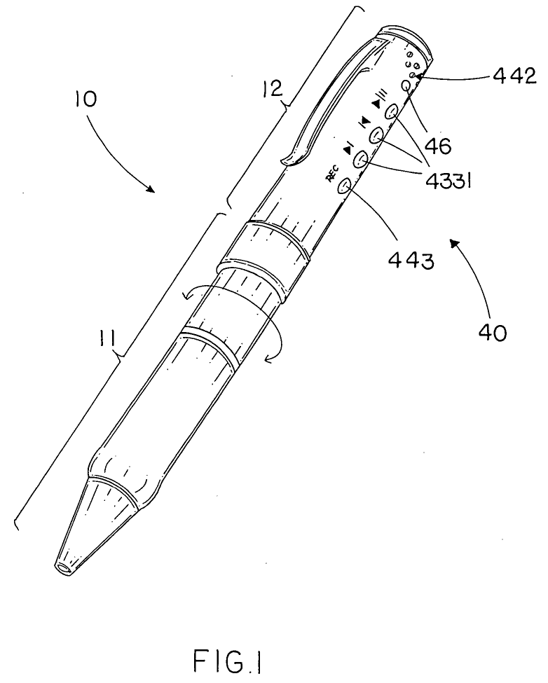

Referring to FIGS. 1 to 3, a multi-function pen according to a preferred embodiment of the present invention is illustrated, wherein the multi-function pen comprises an elongated pen body 10 having a lower body 11 and an upper body 12, and a writing unit 20, having a writing tip 21, disposed in the lower body 11 of the pen body 12.

The multi-function pen further comprises a pen actuator 30 provided at the pen body 10 to move the writing unit 20 from a normal unemployed position that the writing tip 21 of the writing unit 20 is received within the pen body 10 to an operation position that the writing tip 21 of the writing unit 20 is pushed out of the pen body 10 at a lower end 101 thereof.

The multi-function pen further comprises an auxiliary functional arrangement 40, which comprises a memory unit 41 received in the upper body 12 of the pen body 10 and a computer connector 42 extended from the upper body 12 of the pen body 10, wherein the computer connector 42 is electrically connected to the memory unit 41 for detachably connecting with a computer, such that the memory unit 41 forms a removable storage for communicating with the computer to store a computer data thereof.

According to the preferred embodiment, the writing unit 20 is embodied as a pen core coaxially disposed in the lower body 11 of the pen body 10 wherein the writing tip 21 of the writing unit 20 is pointing towards the lower end 101 of the pen body 10.

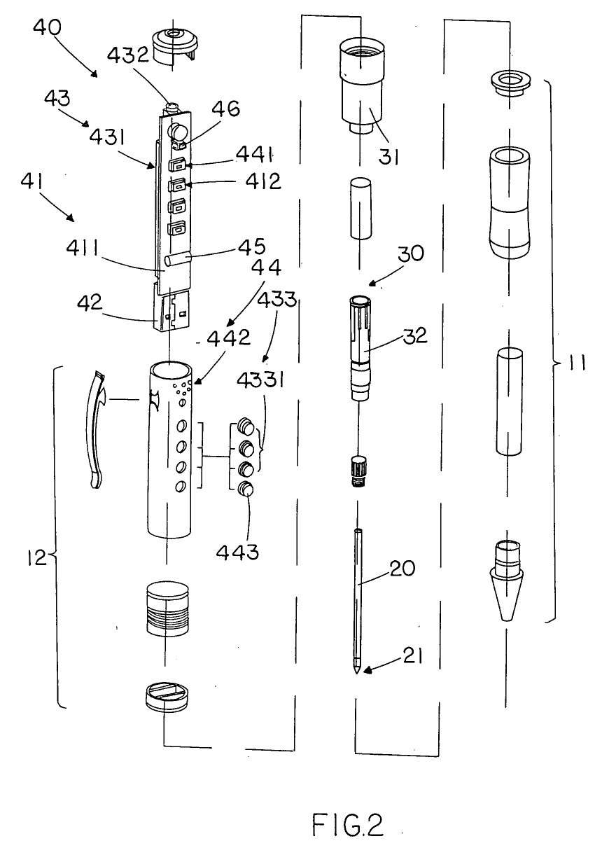

The pen actuator 30 comprises an actuating rotor 31 rotatably mounted on the lower body 11 of the pen body 10 and a writing unit driver 32 mounted in the lower body 11 of the pen body 10 and arranged in such a manner that when the actuating rotor 31 is rotated with respect to the lower body 11 of the pen body 10, the writing unit driver 32 is driven to move the writing unit 20 between the unemployed position and the operation position. In addition, the lower body 11 of the pen body 10 can be disassembled into several parts to replace the writing unit 20 as shown in FIG. 2.

The memory unit 41 comprises an elongated circuit board 411 supported within the upper body 12 of the pen body 10 and a memory chip 412 electrically mounted on the circuit board 411 for storing the computer data. Accordingly, the memory chip 412 has a predetermined storage capacity such as 64 MB to store the computer data such as document data, music data or voice data.

The computer connector 42 is electrically connected to the circuit board 411 to communicate with the memory chip 412, wherein the computer connector 412 is adapted for detachably connecting with the computer to transfer the computer data between the memory chip 412 and the computer. Accordingly, the computer connector 412 is embodied as a USB connector adapted to be recognized by and compatible with the computer such that the computer connector is adapted for detachably connecting with any existing computer to transfer the computer data between the memory unit 41 and the computer. Alternatively, the computer connector 42 can be a “USB 2.0” connector or a “FireWire” connector that is able to transfer the computer readable data to the computer in a high-speed manner.

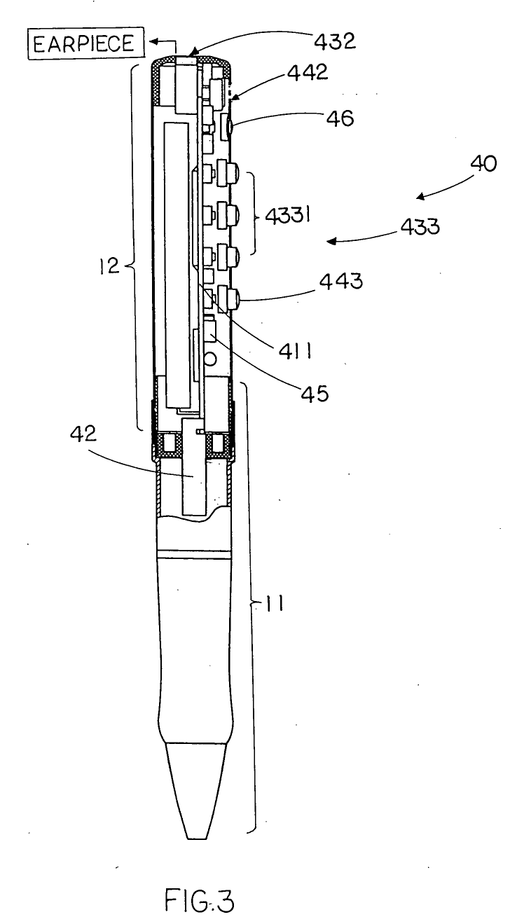

As shown in FIG. 3, the upper body 12 of the pen body 10 is detachably attached to the lower body 11 of the pen body 10 wherein the lower body 11 of the pen body 10 has a top receiving cavity 111 receiving a lower end portion of the upper body 12 of the pen body 10.

The computer connector 42 is downwardly extended from a bottom end of the upper body 12 of the pen body 10 wherein the computer connector 42 is received in the top receiving cavity 111 of the lower body 11 of the pen body 10 when the upper body 12 of the pen body 10 is detachably mounted to the lower body 11 thereof. Accordingly, a length of the upper body 12 of the pen body 10 is equal to a length of the lower body 11 thereof such that the lower body 11 of the pen body 10 constructs as an individual pen holder to form a writing instrument. Therefore, the user is able to use the lower body 11 of the pen body 10 as the writing instrument while the upper body 12 of the pen body 10 is detached from the lower body 11 thereof to communicate with the computer at the same time.

In addition, when the computer connector 412 is received in the top receiving cavity 111 of the lower body 11 of the pen body 10, the lower body 11 of the pen body forms as an accommodation not only protecting the computer connector 42 therein but also preventing the computer connector 42 from being lost accidentally.

As shown in FIGS. 2 and 3, the auxiliary functional arrangement 40 further comprises an audio player 43 electrically connected to the memory unit 41 for playing a music data stored therein. The audio player 43 comprises a player circuit 431 mounted on the circuit board 411 of the memory unit 41, an audio outlet 432 provided at a top ceiling of the upper body 12 of the pen body 10, and a player control 433 provided on a peripheral wall of the upper body 12 to activate the player circuit 431 for playing the audio data through the audio outlet 432.

According to the preferred embodiment, the audio data can be a “MP3” format, “WMA” format or other audio format that has relatively high compression file to minimize the size of the audio data so as to maximize the audio data stored in the memory unit 41.

The audio outlet 432 is embodied as an earplug for detachably connecting with an earpiece wherein the audio outlet 432 is provided on the top ceiling of the pen body 10 such that the user is able to listen to the music via the earpiece during writing. It is worth to mention that the player circuit 431 is built-in with the circuit board 411 of the memory unit 41 to communicate with the memory chip 412.

The player control 433 comprises a plurality of control buttons 4331 operatively mounted on the peripheral wall of the upper body 12 of the pen body 10 to activate the player circuit 431. Since the player control 433 is provided at the upper body 12 of the pen body 10, the player control 433 will not be actuated accidentally during writing. In other words, the audio player 43 is individually operated during writing. It is worth to mention that the upper body 12 of the pen body 10 forms a portable music player, having a compact size, when the upper body 12 of the pen body 10 is detached from the lower body 11 thereof.

The auxiliary functional arrangement 40 further comprises a recording device 44 for voice recording, wherein the recording device 44 comprises a recording circuit 441 electrically connected to the memory unit 41, a recording inlet 442 provided at an upper end of the upper body 12 of the pen body 10, and a recording control 443 provided at the peripheral wall of the upper body 12 to operatively control the recording device 44 for recording a voice recorded via the recording inlet 442 and for playing back the voice stored in the memory unit 41.

Accordingly, the recording circuit 441 is built-in with the circuit board 411 to communicate with the memory chip 412 wherein the recording circuit 441 is arranged for converting the voice input through the recording inlet 442 into a readable digital form so as to store in the memory chip 412. It is worth to mention that the recording inlet 442 is provided at the upper end of the upper body 12 of the pen body 10 such that the pen body 10 forms an elongated microphone shaft to enhance the practical use of the recording device 44.

The recording control 443 is embodied as a record button provided at the peripheral wall of the upper body 12 of the pen body 10 to activate the recording circuit 441 for start recording the voice and for playing back the voice. Therefore, the user is able to record his or her voice and to listen to the play back during writing.

For enhancing the use of the multi-function pen, the auxiliary functional arrangement 40 further comprises a rechargeable battery circuit 45, such as a capacitor, electrically mounted to the circuit board 411 of the memory unit 41 as a power supply of the auxiliary functional arrangement 40. Accordingly, the computer connector 42 functions as an electric adapter to recharge the rechargeable battery circuit 45. In other words, when the computer connector 42 is electrically connected to the computer, the computer connector 42 forms a communication bridge not only communicating between the memory unit 41 and the computer for data transfer but also recharging the rechargeable battery circuit 45 at the same time.

A signal indicator 46, which is electrically extended from the memory unit 41, is provided at the peripheral wall of the upper body 12 of the pen body 10 to indicate the operation of the auxiliary functional arrangement 40. According to the preferred embodiment, the signal indicator 46 is a light indicator, such as a LED, extended from the circuit board 411 to the peripheral wall of the upper body 12 of the pen body 10 such that the signal indicator 46 generates a light signal to indicate the operation of the audio player 43 and the recording device 44.

Therefore, the multi-function pen of the present invention is constructed as an all-in-one pen for storing computer readable data such as music data, document data and/or voice data in the memory unit 41. Therefore, the user is able to use the multi-function pen to play the music via the audio player 43, to communicate with the computer via the computer connector 42, and recording and playing back the recorded voice via the recording device 44.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1. A multi-functional pen, comprising:
an elongated pen body having a lower body and an upper body;
a writing unit, having a writing tip, disposed in said lower body of said pen body;
a pen actuator provided at said pen body to move said writing unit from a normal unemployed position that said writing tip of said writing unit is received within said pen body to an operation position that said writing tip of said writing unit is pushed out of said pen body at a lower end thereof; and
an auxiliary functional arrangement, which comprises:
a memory unit received in said upper body of said pen body; and
a computer connector extended from said upper body of said pen body, wherein said computer connector is electrically connected to said memory unit for detachably connecting with a computer, such that said memory unit forms a removable storage for communicating with said computer to store a computer data thereof.

2. The multi-functional pen, as recited in claim 1, wherein said memory unit comprises a circuit board supported within said upper body of said pen body and a memory chip electrically mounted on said circuit board for storing said computer data, wherein said computer connector is electrically connected to said circuit board to operatively communicate with said memory chip.

3. The multi-functional pen, as recited in claim 1, wherein said lower body of said pen body, having a top receiving cavity, is detachably attached to said upper body, wherein said computer connector is downwardly extended from a bottom end of said upper body such that said computer connector is received in said top receiving cavity of said lower body of said pen body when said upper body of said pen body is detachably mounted to said lower body thereof.

4. The multi-functional pen, as recited in claim 2, wherein said lower body of said pen body, having a top receiving cavity, is detachably attached to said upper body, wherein said computer connector is downwardly extended from a bottom end of said upper body such that said computer connector is received in said top receiving cavity of said lower body of said pen body when said upper body of said pen body is detachably mounted to said lower body thereof.

5. The multi-functional pen, as recited in claim 1, wherein said auxiliary functional arrangement further comprises an audio player electrically connected to said memory unit for playing a music data stored therein, wherein said audio player comprises a player circuit electrically connected to said memory unit, an audio outlet provided at a top ceiling of said upper body of said pen body, and a player control provided on a peripheral wall of said upper body to activate said player circuit for playing said audio data through said audio outlet.

6. The multi-functional pen, as recited in claim 2, wherein said auxiliary functional arrangement further comprises an audio player electrically connected to said memory unit for playing a music data stored therein, wherein said audio player comprises a player circuit electrically connected to said memory unit, an audio outlet provided at a top ceiling of said upper body of said pen body, and a player control provided on a peripheral wall of said upper body to activate said player circuit for playing said audio data through said audio outlet.

7. The multi-functional pen, as recited in claim 4, wherein said auxiliary functional arrangement further comprises an audio player electrically connected to said memory unit for playing a music data stored therein, wherein said audio player comprises a player circuit electrically connected to said memory unit, an audio outlet provided at a top ceiling of said upper body of said pen body, and a player control provided on a peripheral wall of said upper body to activate said player circuit for playing said audio data through said audio outlet.

8. The multi-functional pen, as recited in claim 1, wherein said auxiliary functional arrangement further comprises a recording device for voice recording, wherein said recording device comprises a recording circuit electrically connected to said memory unit, a recording inlet provided at an upper end of said upper body of said pen body, and a recording control provided at a peripheral wall of said upper body to operatively control said recording device for recording a voice recorded via said recording inlet and for playing back said voice stored in said memory unit.

9. The multi-functional pen, as recited in claim 4, wherein said auxiliary functional arrangement further comprises a recording device for voice recording, wherein said recording device comprises a recording circuit electrically connected to said memory unit, a recording inlet provided at an upper end of said upper body of said pen body, and a recording control provided at a peripheral wall of said upper body to operatively control said recording device for recording a voice recorded via said recording inlet and for playing back said voice stored in said memory unit.

10. The multi-functional pen, as recited in claim 7, wherein said auxiliary functional arrangement further comprises a recording device for voice recording, wherein said recording device comprises a recording circuit electrically connected to said memory unit, a recording inlet provided at an upper end of said upper body of said pen body, and a recording control provided at said peripheral wall of said upper body to operatively control said recording device for recording a voice recorded via said recording inlet and for playing back said voice stored in said memory unit.

11. The multi-functional pen, as recited in claim 1, wherein said auxiliary functional arrangement further comprises a rechargeable battery circuit electrically mounted to said memory unit as a power supply of said auxiliary functional arrangement, wherein said computer connector functions as an electric adapter to recharge said rechargeable battery circuit.

12. The multi-functional pen, as recited in claim 7, wherein said auxiliary functional arrangement further comprises a rechargeable battery circuit electrically mounted to said memory unit as a power supply of said auxiliary functional arrangement, wherein said computer connector functions as an electric adapter to recharge said rechargeable battery circuit.

13. The multi-functional pen, as recited in claim 10, wherein said auxiliary functional arrangement further comprises a rechargeable battery circuit electrically mounted to said memory unit as a power supply of said auxiliary functional arrangement, wherein said computer connector functions as an electric adapter to recharge said rechargeable battery circuit.

14. The multi-functional pen, as recited in claim 1, wherein said computer connector is a “USB” connector.

15. The multi-functional pen, as recited in claim 10, wherein said computer connector is a “USB” connector.

16. The multi-functional pen, as recited in claim 13, wherein said computer connector is a “USB” connector.

17. A multi-functional pen, comprising:
an elongated pen body having a lower body and an upper body;
a writing unit, having a writing tip, disposed in said lower body of said pen body;
a pen actuator provided at said pen body to move said writing unit from a normal unemployed position that said writing tip of said writing unit is received within said pen body to an operation position that said writing tip of said writing unit is pushed out of said pen body at a lower end thereof; and
an auxiliary functional arrangement, which comprises:
a memory unit received in said upper body of said pen body; and
an audio player electrically connected to said memory unit for playing a music data stored therein, wherein said audio player comprises a player circuit electrically connected to said memory unit, an audio outlet provided at a top ceiling of said upper body of said pen body, and a player control provided on a peripheral wall of said upper body to activate said player circuit for playing said audio data through said audio outlet.

18. The multi-functional pen, as recited in claim 17, wherein said auxiliary functional arrangement further comprises a recording device for voice recording, wherein said recording device comprises a recording circuit electrically connected to said memory unit, a recording inlet provided at an upper end of said upper body of said pen body, and a recording control provided at a peripheral wall of said upper body to operatively control said recording device for recording a voice recorded via said recording inlet and for playing back said voice stored in said memory unit.

19. The multi-functional pen, as recited in claim 17, wherein said memory unit comprises a circuit board supported within said upper body of said pen body and a memory chip electrically mounted on said circuit board for storing said music data, wherein said player circuit is electrically connected to said circuit board to operatively communicate with said memory chip.

20. The multi-functional pen, as recited in claim 18, wherein said memory unit comprises a circuit board supported within said upper body of said pen body and a memory chip electrically mounted on said circuit board for storing said music data, wherein said player circuit is electrically connected to said circuit board to operatively communicate with said memory chip.

21. The multi-functional pen, as recited in claim 17, wherein said lower body of said pen body is detachably attached to said upper body such that said upper body of said pen body forms a portable music player when said upper body of said pen body is detached from said lower body thereof.

22. The multi-functional pen, as recited in claim 20, wherein said lower body of said pen body is detachably attached to said upper body such that said upper body of said pen body forms a portable music player when said upper body of said pen body is detached from said lower body thereof.

23. The multi-functional pen, as recited in claim 17, wherein said auxiliary functional arrangement further comprises a rechargeable battery circuit electrically mounted to said memory unit as a power supply of said auxiliary functional arrangement.

24. The multi-functional pen, as recited in claim 20, wherein said auxiliary functional arrangement further comprises a rechargeable battery circuit electrically mounted to said memory unit as a power supply of said auxiliary functional arrangement.

25. The multi-functional pen, as recited in claim 22, wherein said auxiliary functional arrangement further comprises a rechargeable battery circuit electrically mounted to said memory unit as a power supply of said auxiliary functional arrangement.
